(19) United States
(12) Patent Application Publication
(10) Pub. No.: US 2020/0226884 A1
(43) Pub. Date: Jul. 16, 2020

(54) GAMING SYSTEMS, APPARATUSES AND METHODS FOR IDENTIFYING AWARDS BASED ON CONTINUITY OF PATHS THROUGH A GAMING GRID

(71) Applicant: KING SHOW GAMES, INC., Minnetonka, MN (US)

(72) Inventors: Anthony GROTTE, Buffalo, MN (US); Steven FUNK, Rosemount, MN (US)

(21) Appl. No.: 16/743,068

(22) Filed: Jan. 15, 2020

Related U.S. Application Data
(60) Provisional application No. 62/792,962, filed on Jan. 16, 2019.

(51) Int. Cl. G07F 17/32; G07F 17/34

(52) U.S. Cl. CPC G07F 17/3269; G07F 17/3225; G07F 17/34; G07F 17/3213; G07F 17/3258

(57) ABSTRACT

Systems, apparatuses and methods for determining gaming activity outcomes based at least in part on the successful progression through a game play area, such as through randomly-generated indicia facilitating or blocking passage through paths of the game play area. In one embodiment, slot game indicia may include passing or blocking indicia. Based on the random presentation of such indicia in a slot game grid, paths through the slot game grid may extend sufficiently to warrant an award, where blocking indicia obstructs such path extension and resultant awards.

### RELATED APPLICATIONS

This application claims the benefit of Provisional Patent Application No. 62/792,962, filed on Jan. 16, 2019, to which priority is claimed pursuant to 35 U.S.C. § 119(e) and which is incorporated herein by reference in its entirety.

### FIELD

This disclosure relates generally to games, and more particularly to systems, apparatuses and methods for determining gaming activity outcomes based at least in part on the continuity of one or more randomly-generated paths through a game play area.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to determine gaming activity outcomes based at least in part on the continuity of one or more randomly-generated paths through a game play area.

In accordance with one embodiment, a slot game apparatus is provided, which includes a display to present symbol locations forming a grid, a user interface including a user input(s) to enable a player to at least initiate slot game events presented via the grid, a wager input device structured to identify and validate player assets and permit the player to play the slot game events when the player assets are provided, and a processor. In this embodiment, the processor is configured to randomly provide, and present via the display, at least a passing indicator or a blocking indicator in each of the symbol locations of the grid. The processor identifies at least a first path of the symbol locations between a first one of the symbol locations and a second one of the symbol locations, and determines whether only the passing indicators are randomly provided along the first path. If the processor determines that any of the blocking indicators are randomly provided along the first path, the processor does not provide an award. Alternatively, if the processor determines that only passing indicators are randomly provided along the first path, the processor provides an award in response thereto.

In a more particular embodiment of such a slot game apparatus, the processor is further configured to identify a second path of the symbol locations between particular symbol locations, and determine whether only the passing indicators are randomly provided along the second path. If the processor determines that any of the blocking indicators are randomly provided along the second path, the processor does not provide an award. If the processor determines that only passing indicators are provided along the second path, the processor provides an award in response thereto.

In another particular embodiment of such a slot game apparatus, the processor is further configured to identify one or more additional paths in addition to the first path between respective pairs of the symbol locations, and determine whether only passing indicators are provided along each of the additional paths. If the processor determines that any of the blocking indicators are randomly provided along the respective one of the additional paths, the processor will not provide an award for the respective one of the additional paths. On the other hand, if the processor determines that only passing indicators are randomly provided along the respective additional path, the processor will provide an award for the respective additional path in response thereto. In one particular embodiment, the processor is configured to identify the first path and the additional path(s) as respective paylines, where in another embodiment the processor is configured to respectively identify the first path and the additional path(s) as particular numbers of adjacent symbol location, where in still another embodiment the processor is configured to identify the first path and the additional path(s) as particular numbers of adjacent symbol locations along respective predetermined paylines.

In another particular embodiment of such a slot game apparatus, the processor is further configured to visually move, via the display, a game position indicator along the symbol locations of the first path unless and until the blocking indicator is associated with one of the symbol locations along the first path. In one particular embodiment, the processor is further configured to provide the award if the blocking indicator does not occur until the game position indicator has passed the entirety of the first path without reaching the symbol location associated with the blocking indicator. In another particular embodiment, the processor is configured to move the game position indicator from the first one of the symbol locations to the second one of the symbol locations, from left to right, along the first path.

In still another embodiment of such a slot game apparatus, the processor is configured to cause the display to present first indicia representative of a passable route for the symbol locations having the passing indicator presented therein, and to present second indicia representative of a blocked route for the symbol locations having the blocking indicator presented therein.

In accordance with another embodiment, a slot game apparatus is provided, which includes a display to present symbol locations forming a grid, a user interface including a user input(s) to enable a player to at least initiate slot game events presented via the grid, a wager input device structured to identify and validate player assets and permit the player to play the slot game events when the player assets are provided, and a processor. In this embodiment, in response to initiating one of the slot game events, the processor is configured to randomly provide, and present via the display, connection indicia at multiple (or up to all) symbol locations of the grid, wherein the connection indicia includes one or more connectors reaching one or more boundaries of its respective symbol location. The processor is configured to determine whether a continuous line may be formed through the symbol locations having their connection indicia align across a plurality of the symbol locations. The processor provides no award if the processor determines that the continuous line is not formed across enough of the symbol locations to reach a destination symbol location, while does provide an award if the processor determines that the continuous line is formed across enough of the symbol locations to reach the destination symbol location.

In a more particular embodiment of such a slot game apparatus, the processor is configured to provide the connection indicia as line segments passing through the center of the symbol location. In a more particular embodiment, the line segments reach to the boundaries of its respective symbol location at the corners and/or side midpoints of the respective symbol location.

In another particular embodiment of such a slot game apparatus, the processor is configured to determine whether a continuous line may be formed through the symbol locations starting from a left column of the symbol locations to the destination symbol location that is to the right of the left column of the symbol locations. In one particular embodiment, the destination symbol location is a fixed number of adjacent ones of the symbol locations away from the left column of the symbol locations. In another particular embodiment, the destination symbol location is along an established payline of the symbol locations relative to the symbol location starting from the left column of the symbol locations.

In accordance with another embodiment, a gaming apparatus is provided that includes a plurality of game segments, each including at least a passing indicator or a blocking indicator. A game segment randomization module is configured to randomly select which of the game segments will be presented in a game grid. A game segment presentation module is configured to present the randomly selected game segments in the game grid. A game segment conductivity determination module is configured to identify unobstructed paths to one or more game grid destinations based on a contiguous string of passing indicators from an originating game grid location to the one or more game grid destinations. A game segment award provision module is configured to provide awards in response to the identification of the unobstructed paths to the one or more game grid destinations.

In a more particular embodiment of such a gaming apparatus, the game segment conductivity determination module is configured to identify the blocking indicators which disrupt respective ones of the unobstructed paths, and the game segment award provision module is configured to disallow providing the awards in response to the identification of the blocking indicator along a path from the originating game grid location to the one or more game grid destinations.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIGS. 3A and 3B depict representative embodiments of gaming activities facilitating outcomes based on a continuity of paths created by symbols or other indicia randomly presented in game play areas.

FIG. 4 depicts a representative slot game embodiment where a processing arrangement is programmed with software and/or firmware to provide various modules to perform game play functions described herein.

FIG. 5 is a flow diagram illustrating one representative manner of facilitating game play and potential awards based on the progression randomly provided through a game grid.

FIGS. 6A and 6B depict representative manners of facilitating awards in gaming activities resembling slot games.

FIGS. 7A and 7B depict another example of a gaming activity where progression through a gaming grid identifies winning outcomes and accompanying payouts.

FIG. 8 is a block diagram of a representative gaming apparatus for identifying awards based on continuity of paths through a gaming grid.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for facilitating gaming activities where success is at least in part based on successful progression through a game play area. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involved advancing a game position indicator(s) in a game play area, and providing awards in response to the game position indicator advancing to one or more threshold positions. For example, in a slot game embodiment, a game grid may be provided, where randomly-provided grid position indicia are provided to reveal whether a moveable game position indicator is allowed to pass through that respective grid position. If the grid position indicia for a plurality of grid positions enable the game position indicator to move to or beyond a threshold location, and/or to or beyond a particular grid position, and/or to or beyond a particular grid position indicia, and/or to or beyond other designed threshold criteria, a winning outcome may result, which may further be associated with a gaming payout.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance. Some of these other types of embodiments will be discussed below as variations to the examples illustrated. However, many other types of games can implement similar techniques and fall within the scope of this disclosed concept.

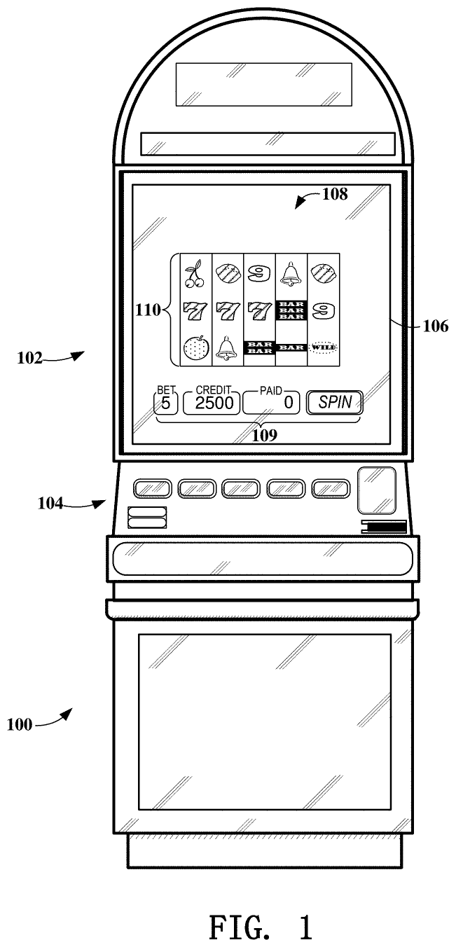

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

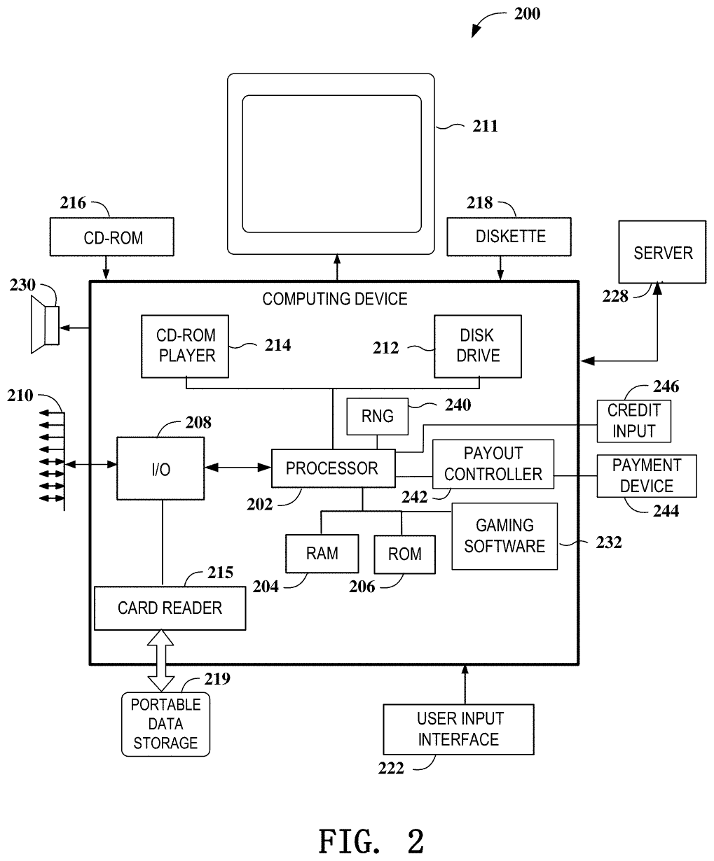

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as pay tables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to be made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot-based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, systems, apparatuses and methods are described for facilitating gaming activities based on a degree of advancement through a game play area. Such “advancement” may be in any one or more directions, whether determined in advance, determined in connection with the game play, randomly determined, etc. In some embodiments, the gaming activities are based on a targeted advancement through a game play area, such as where a game position identifier advances to a designated game play area position, rather than (or in some embodiments in addition to) how far the game position identifier advances.

In some embodiments, a winning result(s) of such game play may occur, for example, when a sufficient progression through the game play area is accomplished. For example, a winning result may be provided if the progression reaches a threshold position(s) on a game grid or other game play area. In some embodiments, different winning results may be provided based on the extent to which a progression is made through the game play area, such as providing a greater payout for a first progression through a game play grid that manages to advance farther and/or in a particular direction than a payout for a second progression that did not advance as far and/or in the particular direction as the first progression.

In some embodiments, locations in the game play area provide indications of whether or not the advancement or progression can continue or will be terminated, slowed, or otherwise obstructed. Such indications may include, for example, visual, audio, tactile, and/or other perceivable indications to the progress through the game play area.

In some embodiments, the progression throughout the game play area may be determined by a threshold position(s) or location(s) in the game play area. For example, a threshold may be indicated along on the game play area, and if the progression advances to or beyond that threshold, a winning result and/or award may be recognized. In other embodiments, the progression may be determined by a threshold position/location(s) within the game play area. For example, where the game play area involves or includes a gaming grid, one or more of the grid locations may represent successful progressions, resulting in a winning result and/or payout. Other desired manners of determining whether and/or when a progression reaches an award threshold may similarly be implemented.

Many embodiments may be described in terms of a slot game, where symbols are matched on paylines to determine payout awards. However, the principles described herein are equally applicable to other games of chance, as described herein and as will be readily apparent to those skilled in the art from the teachings herein.

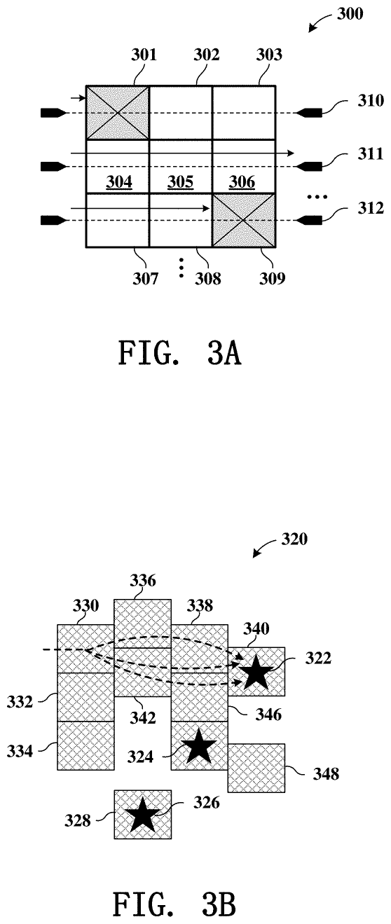

FIG. 3A is described in the context of such a slot game embodiment. This embodiment depicts a gaming grid 300. The gaming grid may be in any configuration, whether symmetric, asymmetric, rectangular, irregular, etc. In the illustrated embodiment, the gaming grid 300 is structured similarly to that of a variety of slot games, where a plurality of grid positions 301, 302, 303, 304, 305, 306, 307, 308 and 309 form the gaming grid 300 in this representative, illustrative embodiment. Other asymmetric and/or irregular gaming grids may be implemented, such as the gaming grid 320 of FIG. 3B, or any other configuration desired.

The embodiment of FIG. 3A is structured to resemble a slot game having a plurality of grid positions 301-309, and award lines 310, 311 and 312 that identify which grid positions include a pathway in which game advancement is measured. For example, in one embodiment, if grid position indicia (e.g., visible symbols, pathways, blocking indicia, etc.) is randomly presented in the various grid positions 301-309, and the grid position indicia represents “passable” features along an award line 310, 311, 312 thereby enabling a complete, unblocked pathway to the end (or other designated position(s) in the game grid 300) of an award line 310, 311, 312, then an award may be presented. In some embodiments, an avatar or other grid position identifier may be used to depict the progression along the respective award line 310, 311, 312 towards the position(s) where it could result in a winning outcome and in some cases an accompanying payout.

For example, if grid position indicia were presented at grid positions 301, 302 and 303 that indicated a passable route from left to right through all three grid positions 301, 302, 303, this could be identified as a winning outcome that provides a particular payout, whether the payout is determined in advance, determined dynamically/randomly, determined based on other criteria, etc. For example, the amount of payout may be dependent upon whether winning outcomes occurred on one or more of award lines 311, 312, whether other symbols are presented in the game grid 300, and/or other desired criteria.

On the other hand, if grid position indicia were presented at any one or more of the grid positions 301, 302, 303 that indicated an impassable route (e.g., blocking indicia), this could be identified as a non-winning outcome since a clear path was not established along the entire award line 310. It should be noted that reaching the “end” of an award line 310 is not required in many embodiments, as reaching particular midpoints may also provide winning outcomes and corresponding payouts. For example, in one embodiment, if grid position indicia indicate a passable route at grid positions 301 and 302, but a blocking grid position indicium at grid position 303, an award may still be provided, albeit potentially a smaller award than had the grid position indicia occurred at a greater number or all of the grid positions 301, 302, 303. Thus, some embodiments involve payouts commensurate with the degree to which unblocked advancement towards one or more grid locations is available.

In still other embodiments, awards and other prizes may be awarded along the way in an unobstructed route, such as providing credit values for each grid position traversed, and/or providing awards corresponding to indicia provided in connection with passable grid position indicia, etc. For example, the grid position indicia at grid position 302 may present passable indicia, while also presenting a 3× (3 times multiplier) and/or credit value (e.g., 50 credits) and/or other award. In other embodiments, such awards may also be associated with blocking indicia, such as a 10-credit award when a pathway along an award line 310, 311, 312 has been blocked.

FIG. 3B depicts an asymmetric and/or irregular game grid 320 in which the principles described herein may also be implemented. In one embodiment, target indicia 322, 324, 326 (star symbols in this example) may be randomly presented to specify which grid positions in which an open path thereto will result in a winning outcome and accompanying payout. For example, in one embodiment, all of the grid positions of the game grid 320 are randomly presented, where they may or may not even be interconnected. For example, based on the random presentation of the game grid 320 in FIG. 3B, no pathway can reach target indicia 326 (unless associated with an embodiment, for example, where grid position 328 additionally exhibits or otherwise indicates a passable route, or in yet other embodiments that a route has been initiated at grid position 328 whether a passable or blocking position). In one embodiment, pathways begin at the leftmost grid positions, such as grid positions 330, 332, 334, and result in winning outcomes if a path(s) can be found through the grid 320 that reaches any one or more of the target indicia 322, 324, 326. For example, if passable indicia are presented at grid positions 330, 336 and 338 thereby creating an unobstructed path to target indicia 322 at grid position 340, a winning outcome (and payout in some embodiments) occurs. Similarly, if passable indicia are presented at grid positions 330, 342 and 338, and/or at grid positions 330, 342, 346, each creating an unobstructed path to target indicia 322 at grid position 340, a winning outcome (and payout in some embodiments) occurs. In a “left-to-right” progression embodiment, if a blocking symbol had occurred at both grid positions 334 and 346, target indicia 322 at grid position 340 could not be reached in the present example, as grid positions 334, 346 are the only grid positions leading to grid position 340 in this example.

In some embodiments, there may be no “target indicia,” but rather positions on the grid 320 represent the target points, such as the rightmost positions 340, 348, or other predetermined or dynamically-determined grid positions.

In some embodiments, all paths leading to the target indicia may provide a payout, while in other embodiments a payout to particular target indicia 322, 324, 326 is provided once if any path leads there. In other embodiments, cumulative awards and/or payout modifiers (e.g., multipliers) May be provided where multiple paths reach a particular target.

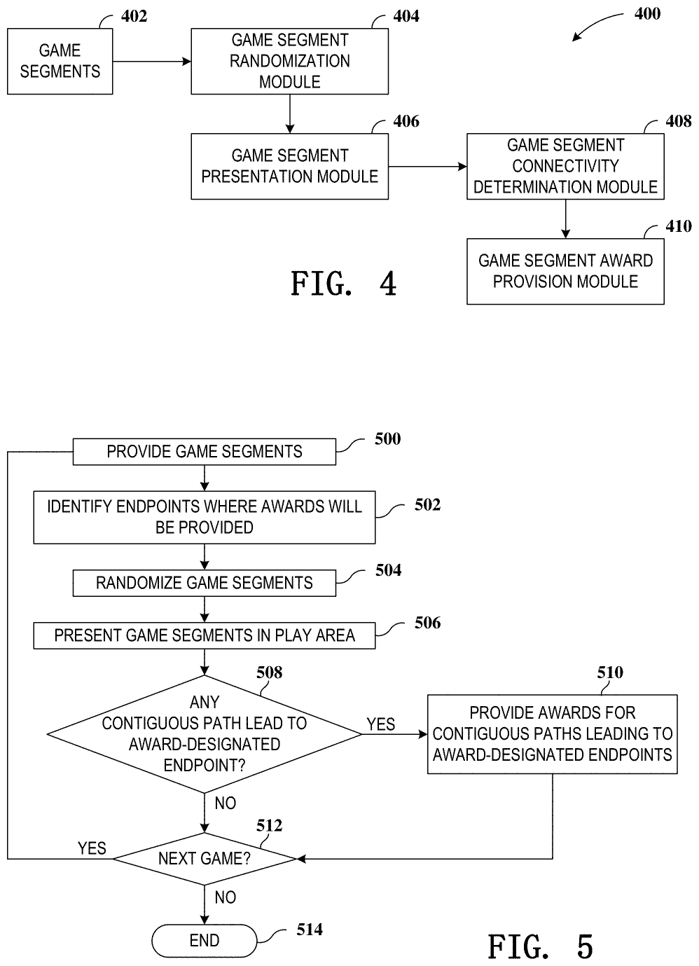

As previously noted, the functionality provided herein may be implemented in hardware on computing devices ranging from large gaming systems, stand-alone kiosks, to small personal devices. FIG. 4 depicts a representative slot game 400 embodiment where a processing arrangement (which is intended to include single processors, multiple processors, or any other processing arrangement) is programmed with software and/or firmware to provide various modules to perform functions described herein. The principles in FIG. 4 are equally applicable to games other than slot games, such as poker or other card games, bingo, roulette, craps, or other games where a result could be replayed in a video/electronic context or properly configured physical implementations. In the representative example of FIG. 4, each of the modules represents software-programmed or otherwise designed/configured hardware to carry out functions to facilitate the gaming features described herein.

The game segments 402 represent at least passable and blocking indicia (and/or audio, tactile indications, etc.). A game segment randomization module 404 randomly determines which game segments 402 will be presented for a particular play of the game. In one embodiment, the game segment randomization module 404 randomize as and presents game segments 402 in a matter analogous to that of the randomization and presentation of symbols in a slot game. The game segment presentation module 406 then presents the various randomly selected game segments 402 on a game grid. The game segment conductivity determination module 408 then determines whether and where unobstructed paths to predetermined and/or spontaneously-determined destinations occur. In one embodiment, such unobstructed paths to appropriate destinations on the game grid can result in winning outcomes and associated payouts, as provided by the game segment award provision module 410.

FIG. 5 is a flow diagram illustrating one representative manner of facilitating game play and potential awards based on the progression randomly provided through a game grid. FIG. 5 and any other flow diagrams represent methods operable via a gaming device and/or gaming system according to representative embodiments. Although various processes are shown in a particular order in these flow diagrams, the order of these processes can be changed in other embodiments without deviating from the scope or spirit of this concept. Accordingly, the order of the processes shown is for illustrative purposes only and is not meant to be restrictive. Additional game processes may also be included between various processes even though they are not shown in these flow diagrams for clarity purposes. Each of the processes may be performed by components in a single game device, such as by a game processor(s), or may be performed in part or whole by a remote server or processor(s) connected to the gaming device via a network. Each process may be encoded in instructions that are stored in one or more memories, a computer-readable medium(s), or another type of storage device(s). The exemplary methods depict representative embodiments of how game operations may be implemented. As discussed herein, many variations exist which may require additional, fewer, or different processes to complete.

In the example of FIG. 5, game segments are provided 500, and endpoints where awards will be provided are identified 502. The game segments may be randomized 504, and presented 506 in a game play area. If it is determined 508 that any continuous path leads to an award-designated endpoint, an award(s) is provided 510 for such contiguous path(s) leading to an award-designated endpoint(s). Otherwise, no award is provided, and if a next game is to be played as determined at decision block 512, the new game segment may again provide 500 game segments. In some embodiments, one or more game segments may remain in a current position when new game segments 500 are provided, while in other embodiments all provided 500 game segments are provided anew.

In one embodiment, a plurality of game segments may be provided, which may be randomly presented in a play area. Endpoints are identified where awards will be provided along established “paylines,” and/or by virtue of adjacency, and/or based on a fixed or random destination(s), and/or via any desired manner of establishing an endpoint in which grid paths may be established and identified. Awards may be provided where such endpoints are reached due to game play “access” paths leading thereto, where blocking indicia may terminate such ability to reach the endpoints where awards are provided.

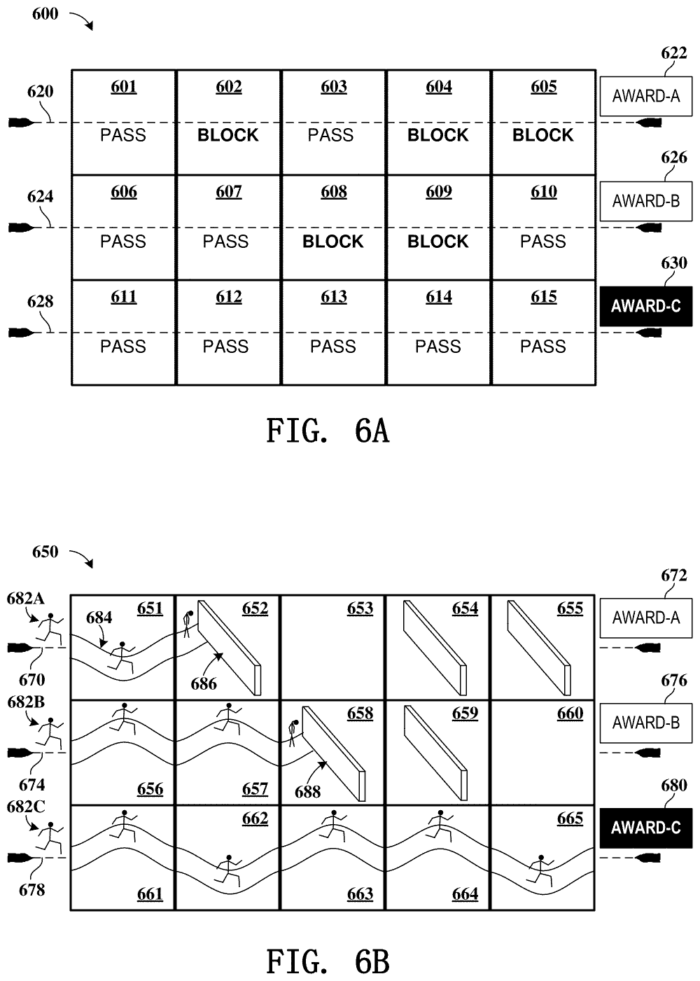

FIGS. 6A and 6B depict representative manners of facilitating awards in gaming activities resembling slot games. In the illustrated embodiment, it is assumed that three award lines or paylines represents the paths that may be cleared or obstructed towards an award(s), although any number of such paths may be provided, in any configuration.

In the example of FIG. 6A, a game grid 600 includes a plurality of grid positions 601-615, which is arranged in a rectangular structure in this representative example. Path 620 leads through grid positions 601-605 towards award-A 622, path 624 leads through grid positions 606-610 towards award-B 626, and path 628 leads through grid positions 611-615 towards award-C 630. Thus, in this example, if the indicia randomly present in the grid positions along a path (e.g., 620, 624, 628 in this example) does not indicate a blocking mechanism or other indicia, then the award at the end of the respective path is awarded.

For example, path 620 passes through grid positions 601, 602, 603, 604 and 605. It is assumed that PASS or BLOCK indicators are randomly presented in each of the grid positions 601, 602, 603, 604 and 605, which is accomplished analogously to a slot game “spin” event in one embodiment. Any type of indicia may be used to indicate whether a grid position is enabling or obstructing passage to its respective ultimate award, including textual information (e.g., PASS or BLOCK), graphical information (e.g., a bridge to pass, and a roadblock to obstruct/stop), etc. In this example, it is assumed that the paths 620, 624, 628 each start at the leftmost grid position, namely grid positions 601, 606, and 611 respectively.

Thus, assume a “spin” event or other randomization of at least PASS and BLOCK indicators, which populate the game grid 600 as presented in FIG. 6A. Along path 620, three BLOCK symbols occurred, namely at grid positions 602, 604 and 605. Therefore, there is no unobstructed path on path 620 to the award-A 622, and therefore award-A 622 is not awarded to the player. Similarly, along path 624, two BLOCK symbols occurred, namely at grid positions 608 and 609, and therefore there is no unobstructed path on path 624 to the award-b 626, and therefore award-B 626 is not awarded to the player. However, along path 628, a PASS indicator was randomly presented at each of the grid positions 611, 612, 613, 614 and 615, thereby providing unobstructed access to the award-C 630, thereby resulting in the award-C 630 being presented to the player. Other embodiments could provide different, more, or less paths than the paths 620, 624 and 628, such as also including a diagonal path using grid positions 611, 607, 603, 609 and 615 to award-C 630, and/or a diagonal path using grid positions 601, 607, 613, 609 and 605 to award-A 622, etc.

FIG. 6B depicts a similar example, although implementing graphical information for the paths towards the respective awards. In this example, an avatar is depicted as moving along a path (for each available path), and continuing towards a respective award until a barrier or other visual obstruction stops the advancement of the avatar on its way to its award. If stopped, the award is not provided in one embodiment.

In the example of FIG. 6B, the game grid 650 includes a plurality of grid positions 651-665, which is arranged in a rectangular structure in this representative example (although any structure or arrangement may be used). Path 670 leads through grid positions 651-655 towards award-A 672, path 674 leads through grid positions 656-660 towards award-B 676, and path 678 leads through grid positions 661-665 towards award-C 680. Thus, in this example, if the indicia randomly present in the grid positions along a path (e.g., 670, 674, 678 in this example) does not present blocking indicia, then the award at the end of the respective path is awarded.

For example, path 670 passes through grid positions 651, 652, 653, 654 and 655. In this example, an avatar 682A is positioned at the beginning of path 670. Passing or blocking indicators are randomly presented in each of the grid positions 651, 652, 653, 654 and 655. In the illustrated embodiment, passing indicators are depicted as traversing trails 684, while blocking indicators are depicted as walls or other barriers 686. In this example, the avatar 682A moves along the path 670 towards the award-A 672 until and unless it encounters a blocking symbol, which it does first at grid position 652 in this example. Thus, the player does not receive the award-a 672 for this “spin” or other gaming event. Similarly, along path 674, the avatar's 682B progress is stopped via barrier 688 at grid position 658, thereby disallowing awarding of award-B 676 to the player.

Along path 678, however, the avatar 682C is not inhibited from advancing all the way to the award-C 680. Particularly, each grid position 661, 662, 663, 664 and 665 are randomly presented with depictions of traversing trails, thereby enabling the avatar 682C to reach the award-C 680 without encumbrances. In some embodiments, one or more traversing trail (i.e. passing) indicators may be held over from prior game plays, or may be fixed, etc. However, in some embodiments, all grid positions 651-665 are randomly presented on each “spin” or other gaming event. In any event, in the example of FIG. 6B, the player will be awarded the award-C 680 as a result of the avatar 682C being able to reach the award-C 680 via the grid positions 661-665 along the path 678.

Thus, games according to the description herein may incorporate themes to represent paths, continuity of paths, barriers, etc. One representative way to envision the game grid is as a landscape with various types of possible terrain. Certain types of terrain may be crossed, such as relatively flat ground, small bodies of water, ice, etc., while other types of terrain may serve as barriers such as mountains, pits, walled areas, etc. In one embodiment, for each spin, each grid position is assigned a random terrain type, and when the spin is complete, an avatar (e.g., hikers, pioneers, trailblazers) would begin on each path. In another themed embodiment, the avatars could be vehicles that would proceed on open road, bridges, etc., while being impeded by broken down or stopped cars, traffic signs and signals, train/animal crossings, etc. In still another representative themed embodiment, the avatar could be a rat, where the grid is a maze, as is classically used by scientists experimenting, where awards on the other side of the paths could be depicted as blocks of cheese or other treats of varying sizes. These represent examples of themed games implementing principals described herein.

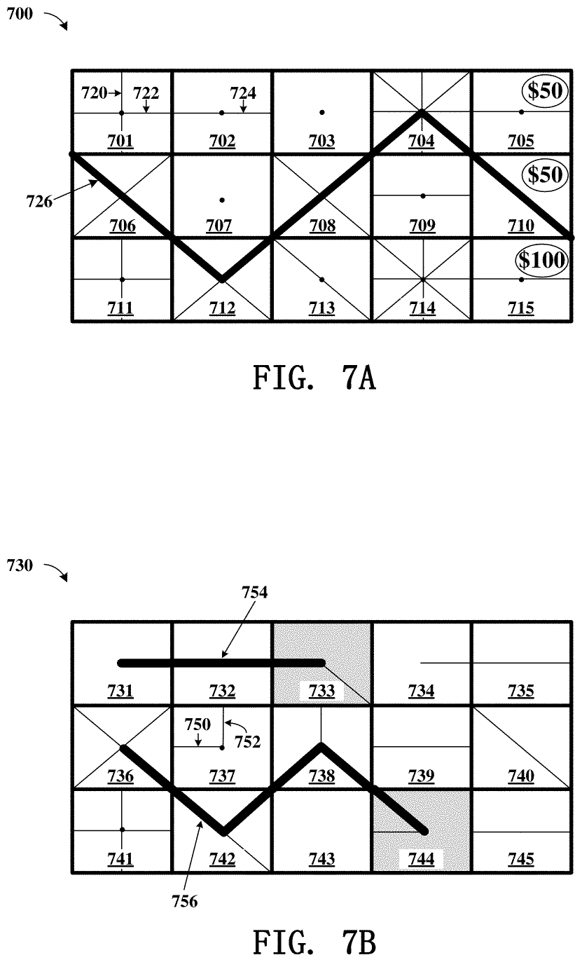

FIGS. 7A and 7B depict another example of a gaming activity where progression through a gaming grid identifies winning outcomes and accompanying payouts. In these examples, visual indications are provided to extend or terminate lines or other shapes that, when connected, may lead to an endpoint(s) resulting in a winning outcome.

In the example of FIG. 7A, lines are used to extend paths towards potential winning endpoints through a grid 700 of grid positions 701-715. Assume, for example, that the rightmost grid positions, 705, 710, 715 are destinations where awards are provided, although any one or more positions may serve as such destinations, regardless of the quantity and whereabouts on the grid 700. In this example, line shapes are randomly provided, which may include no line, a horizontal line, a vertical line, one or more diagonal lines, etc. Because grid positions abut one another in this embodiment, lines from one grid position may connect with lines from other abutting grid positions when the line shapes align at the junction.

For example, grid position 701 includes a vertical line 720 and a horizontal line 722. Grid positions 702, 706, and 707 are adjacent to grid position 701, and therefore lines from grid position 701 may extend to and connect with lines from these adjacent grid positions 702, 706, 707. In this example, and assuming the leftmost grid positions 701, 706, 711 serve as the starting points, only the horizontal line 722 aligns/connects with a line from an adjacent grid position, namely horizontal line 724 from grid position 702. However, no lines connect to line 724 from grid positions 703, 706, 707, 708, and therefore this path towards an award is terminated at grid position 702. As can be seen in this particular example, a grid position having no lines (e.g., grid positions 703, 707) serves as a blocking grid position for all adjacent grid positions, whereas a grid position having all lines including a horizontal line, a vertical line, and both diagonal lines (e.g., grid positions 704, 714) serves as a passing grid position (tantamount to a “wild” symbol) to all adjacent grid positions.

The connectivity of the shapes (lines in this example) is considered for all grid positions 701-715 in a similar manner. From viewing the grid 700 from this “spin” or other gaming event, it can be seen that a continuous line 726 connects from its starting grid position 706, through grid positions 712, 708, 704, and ultimately to grid position 710 where a $50 award is provided. Thus, since a path has been established to an award, that award is provided to the player.

As previously noted, the grid positions associated with awards or winning destinations may be located anywhere in the grid 700. Further, award values may or may not be associated directly with such destinations. For example, rather than the award value being associated with grid position itself, awards may be based on a paytable, such as providing awards depending on how many grid positions are traversed, the wager amount, randomly or otherwise presented payout modifiers (e.g., multipliers), and the like.

In one embodiment, the randomization of such shapes (e.g., lines in this example) may be presented via spinning reels (whether mechanical, electronic, etc.), may visually materialize, or appear in any desired fashion. In one embodiment, the shapes rotate individually, to provide anticipation as to where they will stop (e.g., a horizontal line would end up a vertical line if rotated another ninety degrees). In yet other embodiments, the shapes or other connectivity symbols may drop into place into individual positions, where in other embodiments the shapes are presented as if on vertical reels.

Embodiments may include shapes, such as lines, that do not extend across the entire grid position. For example, FIG. 7B, the game grid 730 includes a plurality of grid positions 731-745, each of which may present lines that are as small as “half” length. For example, a horizontal line may extend from a midpoint of the grid position to an edge of the grid position, such as the “half” horizontal line 750 and “half” vertical line 752 in grid position 737. Such an embodiment may create a statistically more difficult way to connect lines/shapes relative to the embodiment of FIG. 7A where lines extended across the grid position.

In the embodiment of FIG. 7B, a first payout may be provided for involving three grid positions with a continuous path, such as line 754 involving grid positions 731, 732 and 733. This may result in a first payout, such as indicated by a paytable. Similarly, a second payout may be provided for involving four grid positions with a continuous path, such as line 756 involving grid positions 736, 742, 738, and 744. This may result in a second payout, such as indicated by a paytable, which in some embodiments is a greater payout than a continuous path 754 involving three (or fewer) grid positions.

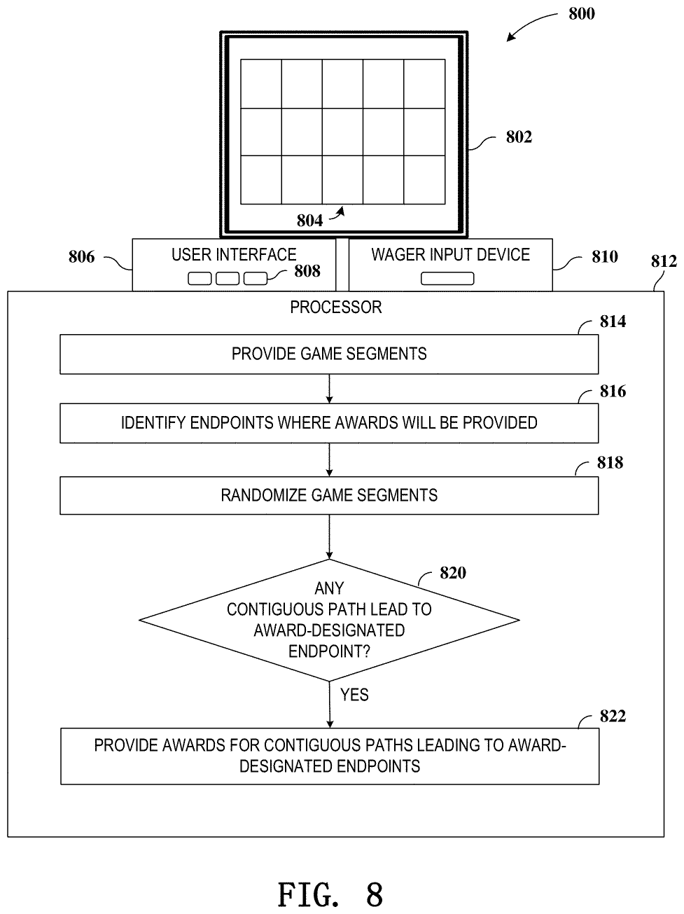

FIG. 8 is a block diagram of a representative gaming apparatus for facilitating gaming outcomes and payouts based on the continuity of shapes, text, or indicative information, through a game play area. In the illustrated embodiment, a slot game device 800 is provided on which players can play slot-type games. Other games may instead be used as a primary game, such as poker, etc. The representative slot game device 800 includes at least a display 802 presenting a slot game symbol array or “grid” 804 of symbols, a user interface 806 including at least one user input 808 to enable a player to initiate a slot game event presented via the slot game grid 804, and a wager input device 810 structured to identify and validate player assets and ultimately permit the player to play the slot game event when the player assets are provided.

The representative slot game device 800 further includes a processor 812 configured to structurally operate as programmed. In the representative embodiment of FIG. 8, the processor is configured to execute code to provide 814 game segments, such as randomly providing game segments indicative of at least continuity-enabling or continuity-prohibiting functionality via the grid 804. The processor is configured to execute code to identify 816 one or more endpoints in the grid 804 where awards will be provided, if the continuity of presented symbols/indicia enables reaching such endpoint(s). The game segments are randomized 818 by the processor, which then determines 820 whether any contiguous path leads to an award-designated endpoint(s). If so, the processor is configured to execute code to provide 822 awards for such contiguous path(s) leading to the award-designated endpoint(s).

Embodiments described herein are for illustrative purposes, as various variations to the teachings herein may be implemented. In one embodiment, the features described herein may be implemented in a slot machine, notwithstanding that some embodiments may not utilize conventional “reels” or “reel strips” (although they may). In one embodiment, the grid positions which serve as symbol windows may function as a dynamic board game board.

Whereas some board games may have fixed game locations, the spinning nature of a slot machine and its video presentation allow the nodes to be possibly changed for each play in accordance with the disclosure herein. In one embodiment, the goal is to obtain unobstructed paths through the game play area, thereby obtaining access to prizes at the end and possibly along the way as well. Avatars and/or other movable characters/graphics may optionally be used to depict the progression along these paths to animate gameplay.

In one embodiment, a goal of play is to get from the beginning of a path to the end of the path. Assuming an embodiment involving left to right movement (though movement could be reversed, vertically oriented, etc.), grid nodes may be set when a “spin” or other randomization is complete. In one embodiment, moveable avatars begin moving along respective paths (if multiple paths), where the movement is constrained to the path in one embodiment, although the path may not be straight but rather may be jagged or otherwise irregular. In one embodiment, the avatars' ability to move will be determined by the properties of the nodes it encounters. Though these nodes may be very rich and diverse in features to produce more complex games, a simple case involve nodes having a single property—whether they can be traversed or not. If the node is passable, the avatar will continue moving along its path. Otherwise it will stop either on the node in question or prior to it.

Awards may be set to any type of award desired, including paytable-based awards, credit values, bonus game triggers, free games triggers, payout modifiers, and the like. Such awards may be randomly determined for each potential path on a particular spin event, may be the same for each potential path on a particular spin event, may change on each spin event, may be fixed for every spin event or during some event (e.g., during a free games event), or the like. Thus, particular awards noted herein are noted for purposes of illustration and example, and not of limitation.

Further, where some embodiments described herein refer to grid positions having one property (pass or no-pass), the grid positions may be provided with multiple properties. For example, a certain “terrain” along a path may persist for more than one spin or other gaming event. One embodiment may involve a “slowing” property where the progression along a path is slowed, thereby implementing further spins or other gaming events, without ending the advancement at that time. Other grid position properties may speed up travel, where avatars could then potentially persist across multiple spin events. In another embodiment, an ice-type terrain segment in a grid position could cause the avatar to “slip” one position off track, possibly off the entire grid thereby ending that gaming event, or potentially get onto another path. Adjacent terrains of the same type could combine to form blocks.

Overlays could be included as possible ways to break obstructions or save avatars from traps. An overlay could drop a rope to save an avatar from quicksand or deep water. It could give them a helicopter lift over a mountain. It could place a bridge or vine swing over a pit.

The grid positions would not have to look like a normal slot game symbol windows, and could be hexagons or other mating shapes, or even irregular patterns as previously described.

The paths could change on each spin, or all or part of the paths could persist for multiple, or all, spin events. In one embodiment, such paths are automatically generated by the system, where in other embodiments the player may set them.

In some embodiments, multiple avatars may be sent down the same path for multiplied outcomes, or in other embodiments to take different alternative paths from a common starting point.

Awards could be placed on the nodes as well so the avatar could collect some payout without entirely traversing its path.

A free games bonus may be themed as developed land or great plains where the avatars won't have to worry about encountering mountains for example. Having less obstacles present may increase the chances of payouts. The base game play could be set in a more rough and undeveloped landscape. In one embodiment, advancing avatars may persist until they reach then end of the path, or perish.

Avatars themselves could have different properties assigned to them as well. Some could be well adapted to water environments, while worse on land. Conversely, other avatars may excel on land, while succumbing to water. Some avatars could jump far, or temporarily fly. In some embodiments, such avatar and/or landscape properties may warrant utilizing a three-dimensional game play area.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A slot game apparatus comprising:
a display presenting a plurality of symbol locations forming a grid;
a user interface including at least one user input to enable a player to at least initiate slot game events presented via the grid;
a wager input device structured to identify and validate player assets, and to permit the player to play the slot game events when the player assets are provided; and
a processor configured to:
in response to initiating of one of the slot game events, randomly provide, and present via the display, at least a passing indicator or a blocking indicator in each of the symbol locations of the grid;
identify at least a first path of the symbol locations between a first one of the symbol locations and a second one of the symbol locations;
determine whether only the passing indicators are randomly provided along the first path;
if any of the blocking indicators are randomly provided along the first path, do not provide an award; and
if only the passing indicators are randomly provided along the first path, provide an award in response thereto.

2. The slot game apparatus of claim 1, wherein the processor is further configured to:
identify a second path of the symbol locations between particular ones of the symbol locations;
determine whether only the passing indicators are randomly provided along the second path;
if any of the blocking indicators are randomly provided along the second path, not provide an award; and
if only the passing indicators are randomly provided along the second path, provide an award in response thereto.

3. The slot game apparatus of claim 1, wherein the processor is further configured to:
identify one or more additional paths in addition to the first path between respective pairs of the symbol locations;
determine whether only the passing indicators are randomly provided along each of the one or more additional paths;
if any of the blocking indicators are randomly provided along the respective one of the additional paths, not provide an award for the respective one of the additional paths; and
if only the passing indicators are randomly provided along the respective one of the additional paths, provide an award for the respective one of the additional paths in response thereto.

4. The slot game apparatus of claim 3, wherein the processor is configured to identify the first path and the one or more additional paths as respective paylines.

5. The slot game apparatus of claim 3, wherein the processor is configured to respectively identify the first path and the one or more additional paths as particular numbers of adjacent ones of the symbol locations.

6. The slot game apparatus of claim 3, wherein the processor is configured to identify the first path and the one or more additional paths as particular numbers of adjacent ones of the symbol locations along respective predetermined paylines.

7. The slot game apparatus of claim 1, wherein the processor is further configured to visually move, via the display, a game position indicator along the symbol locations of the first path unless and until the blocking indicator is associated with one of the symbol locations along the first path.

8. The slot game apparatus of claim 7, wherein the processor is further configured to provide the award if the blocking indicator does not occur until the game position indicator has passed the entirety of the first path without reaching the symbol location associated with the blocking indicator.

9. The slot game apparatus of claim 7, wherein the processor is configured to move the game position indicator from the first one of the symbol locations to the second one of the symbol locations, from left to right, along the first path.

10. The slot game apparatus of claim 1, wherein the processor is configured to cause the display to present first indicia representative of a passable route for the symbol locations having the passing indicator presented therein, and to present second indicia representative of a blocked route for the symbol locations having the blocking indicator presented therein.

11. A slot game apparatus comprising:
a display presenting a plurality of symbol locations forming a grid;
a user interface including at least one user input to enable a player to at least initiate slot game events presented via the grid;
a wager input device structured to identify and validate player assets, and to permit the player to play the slot game events when the player assets are provided; and
a processor configured to:
in response to initiating of one of the slot game events, randomly provide, and present via the display, connection indicia at a plurality of the symbol locations of the grid, wherein the connection indicia includes one or more connectors reaching one or more boundaries of its respective symbol location;
determine whether a continuous line may be formed through the symbol locations having their connection indicia align across a plurality of the symbol locations;
provide no award if the continuous line is not formed across enough of the symbol locations to reach a destination symbol location; and
provide an award if the continuous line is formed across enough of the symbol locations to reach the destination symbol location.

12. The slot game apparatus of claim 11, wherein the processor is configured to provide the connection indicia as line segments passing through the center of the symbol location.

13. The slot game apparatus of claim 12, wherein the line segments reach to the one or more boundaries of its respective symbol location at the corners and/or side midpoints of the respective symbol location.

14. The slot game apparatus of claim 11, wherein the processor is configured to determine whether a continuous line may be formed through the symbol locations starting from a left column of the symbol locations to the destination symbol location that is to the right of the left column of the symbol locations.

15. The slot game apparatus of claim 14, wherein the destination symbol location is a fixed number of adjacent ones of the symbol locations away from the left column of the symbol locations.

16. The slot game apparatus of claim 14, wherein the destination symbol location is along an established payline of the symbol locations relative to the symbol location starting from the left column of the symbol locations.

17. A gaming apparatus comprising:
a plurality of game segments, each including at least a passing indicator or a blocking indicator;
a game segment randomization module configured to randomly select which of the game segments will be presented in a game grid;
a game segment presentation module configured to present the randomly selected game segments in the game grid;
a game segment conductivity determination module configured to identify unobstructed paths to one or more game grid destinations based on a contiguous string of passing indicators from an originating game grid location to the one or more game grid destinations; and
a game segment award provision module configured to provide awards in response to the identification of the unobstructed paths to the one or more game grid destinations.

18. The gaming apparatus of claim 17, wherein the game segment conductivity determination module is configured to identify the blocking indicators which disrupt respective ones of the unobstructed paths, and wherein the game segment award provision module is configured to disallow providing the awards in response to the identification of the blocking indicator along a path from the originating game grid location to the one or more game grid destinations.
